(19) United States
(12) Patent Application Publication
(10) Pub. No.: US 2012/0273306 A1
(43) Pub. Date: Nov. 1, 2012

(54) Activity Reporting System

(76) Inventors: John Alan Pangrazio, Volo, IL (US); Robert Thomas Pangrazio, Jonesboro, AR (US)

(21) Appl. No.: 13/459,997

(22) Filed: Apr. 30, 2012

Related U.S. Application Data
(60) Provisional application No. 61/479,920, filed on Apr. 28, 2011.

(51) Int. Cl. B66F 9/075; G01L 1/00

(52) U.S. Cl. 187/222; 187/393; 73/862.381

(57) ABSTRACT

An improved activity detection system for use on a lift truck can be generally stated as including a detection apparatus and a processor apparatus. The detection apparatus can be generally stated as including at least one of a load detector and a movement detector. The processor apparatus can be generally stated as including a storage for storing an output from the detection apparatus.

### CROSS-REFERENCE TO RELATED APPLICATION

This application claims priority from U.S. Provisional Patent Application Ser. No. 61/479,920 filed Apr. 28, 2011, the disclosures of which are incorporated herein by reference.

### BACKGROUND

1. Field

The disclosed and claimed concept relates generally to devices such as lift trucks that are used in moving objects from one location to another within a facility and, more particularly, to an activity reporting system that assesses and outputs signals indicative of the extent to which lift trucks and the like are active or inactive.

2. Related Art

Devices such as lift trucks, forklifts, fork trucks, towmotors, and the like are relatively well known for use in transporting objects from place to place within a facility. For instance, objects in a warehouse are retrieved by a forklift when needed and thus are transported from a storage location in the warehouse to another location for use, purchase, placement onto a truck for shipment and delivery, etc. In a shipping terminal, objects removed from an incoming transport are picked up by a forklift, removed from the incoming transport, and are transported by the forklift to an intermediate storage location and/or to an appropriate outgoing transport where the object is deposited. Other examples of the uses of forklifts will be apparent to those skilled in the art.

It is also known, however, that such forklifts and other devices have a certain level of inactivity which can occur, for instance, when the forklift is traveling from one location to another within a facility in an unladen condition, i.e., when it is traveling without an object on its forked platform. Other types of inactivity can occur when a forklift is stationary, whether or not it has an object on its forked platform, and whether or not its engine is in operation. That is, a forklift can be considered to be in an inactive condition when it is in an unmoving state, even if it has an object on its forked platform and its engine is running Depending upon the needs of the individual user, a certain condition of a forklift may be considered to be an “inactive” condition, whereas the same condition may be considered by a different user to be an “active” condition. Improvements on existing systems would be desirable.

### SUMMARY

An improved activity detection system for use on a lift truck or other such device includes a detection apparatus and a processor apparatus. The detection apparatus is configured to generate one or more signals that are indicative of a level of activity or inactivity of the lift truck, and the processor apparatus is structured to detect such signals and to store data representative of such signals. The processor apparatus is also configured to include one or more routines that filter noise from signals from the detection apparatus and can also wirelessly transmit the stored data to a separate reporting device remote from the lift truck.

Accordingly, an aspect of the disclosed and claimed concept is to provide an improved activity detection system structured to be used on a lift truck and configured to detect and store data that is indicative of periods of activity and periods of inactivity of the lift truck.

Another aspect of the disclosed and claimed concept is to provide a fork truck system that includes a fork truck upon which is installed an activity detection system as described in the preceding paragraph.

Another aspect of the disclosed and claimed concept is to provide an activity reporting system that includes a reporting device and that also includes a fork truck system as described in the preceding paragraph.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved activity reporting system in accordance with the disclosed and claimed concept;

FIG. 2 is a schematic depiction of an improved activity detection system of the activity reporting system of FIG. 1;

FIGS. 3A-3C schematically depict three exemplary signals that can occur within the activity detection system of FIG. 2; and

FIG. 4 is a schematic depiction of movement of a fork truck system having installed thereon the activity detection system of FIG. 2 and moving within a schematically depicted facility.

Similar numerals refer to similar parts throughout the specification.

### DESCRIPTION

An improved activity reporting system 4 in accordance with the invention is depicted schematically in FIG. 1. The activity reporting system 4 includes a reporting device 8 and a fork truck system 12 which, in the embodiment depicted herein, are in wireless communication with one another. As is set forth elsewhere herein, however, the reporting device 8 and the fork truck system 12 can use wired communication therebetween without departing from the present concept. The fork truck system 12 includes a fork truck 16 to which is mounted an activity detection system 20 in accordance with the invention. As employed herein, the expressions “fork truck” and “lift truck” shall refer generally to self-powered devices that are configured for transporting objects from one location to another within a facility and would include, by way of example, forklifts, stacker trucks, trailer loaders, side loaders, towmotors, fork hoists, motorized hand pallets, and the like without limitation.

The exemplary fork truck 16 includes a drive train 24 having an engine, transmission, wheels, etc. The exemplary fork truck 16 further includes a body 28 mounted to the drive train 24 that includes a frame, a seat, a roll cage, etc. The fork truck 16 additionally includes a lift apparatus 32 affixed to the body 28 and comprising a pair of masts 36 (only one of which is depicted in FIG. 1) to which is movably mounted a platform 40 that includes a pair of forks (only one of which is depicted in FIG. 1). As is understood in the relevant art, the platform 40 is selectively movable in a vertical direction (from the perspective of FIG. 1) in order to lift and carry an object 42 from one location to another within a facility. The object 42 typically is situated on a pallet (not expressly depicted in FIG. 1) which enables the object 42 to be picked up with the fork truck 16. The object 42 can be any type of object without limitation.

The activity detection system 20 is advantageously configured to record certain data regarding the operation of the fork truck 16 and is also configured in the depicted exemplary embodiment to communicate the recorded, i.e., saved, data to the reporting device 8. The reporting device 8 could be, by way of example and without limitation, a computer having a wireless transceiver for receiving the data from the activity detection system 20 and that is connected with another computer upon which a business application is deployed. The reporting device 8 can take virtually any form as long as it is capable of receiving data from the activity detection system 20, and the reporting device 8 thus could be something as simple as a storage array made of FLASH memory that has a wired connection with the activity detection system 20 and that can be connected with another device to transfer the data thereto.

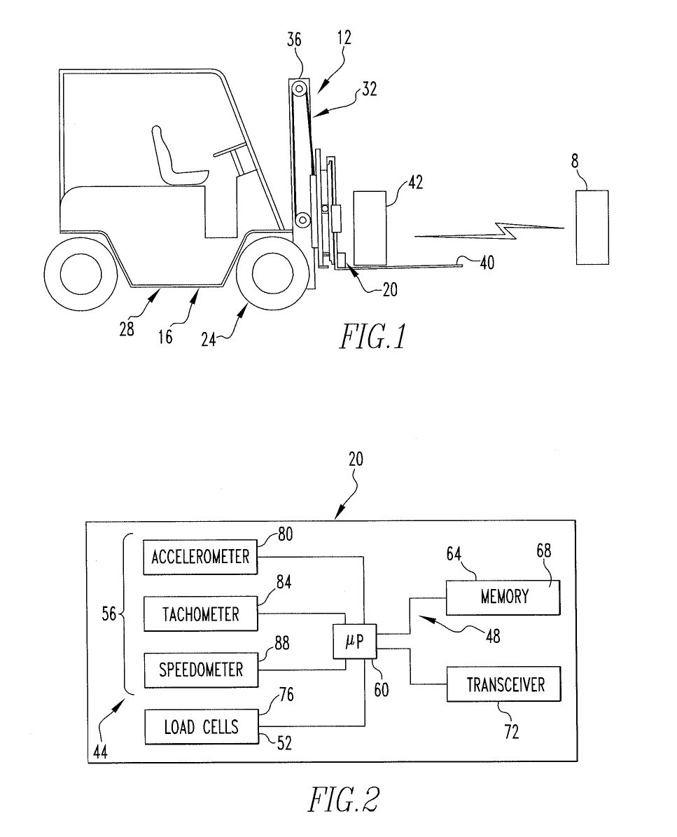

As can best be understood from FIG. 2, the schematically depicted activity detection system 20 can be said to include a detection apparatus 44 and a processor apparatus 48. As can be generally understood, the detection apparatus 44 is configured to detect any one or more of a variety of conditions that occur during operation or non-operation of the fork truck 16 and communicates data reflective of such conditions to the processor apparatus 48 for processing thereof. In the exemplary embodiment depicted herein, the detection apparatus 44 comprises a load detector 52 and a movement detector 56. As will be described in greater detail elsewhere herein, data from both the load detector 52 and the movement detector 56 are used by the activity detection system 20 to characterize the nature and/or extent of activity of the fork truck 16 over a period of time. It is understood, however, that other embodiments of the activity detection system 20 may be configured to include only the load detector 52 or only the movement detector 56 or only limited components thereof in any combination without limitation and still provide meaningful benefit to the user of such an activity detection system.

The processor apparatus 48 is depicted herein as including a processor 60 and a memory 64 that interfaces with the processor 60. The processor 60 can be any of a wide variety of processors such as are generally known in the relevant art and can include, by way of example and without limitation, a microprocessor μP. The memory 64 can be any of a wide variety of storage devices that are cooperable with the processor 60 and can include, by way of example, RAM, ROM, EPROM, FLASH, and the like without limitation and can function as a storage area of a computer system, by way of example. The memory 64 has stored therein a number of routines that are depicted generally at the numeral 68 and which are executable on the processor 60. The routines 68 include, among other routines 68, a filter routine 68 which, when executed on the processor 60, is configured to operate on a signal or a set of data to filter from the signal or data, respectively, certain predetermined artifacts in order to produce a filtered signal or filtered data as needed for use in or by other applications. The filter routine 68 can be referred to herein as a “filter” or other appropriate term, and it is noted that other filters of a solid state or other configuration can potentially be employed in place of portions of the filter routine 68 or the entirety of the filter routine 68 without departing from the present concept.

The exemplary load detector 52 depicted herein includes one or more load cells 76 that are situated on the platform 40 or are otherwise disposed to detect the weight of the object 42 when situated on the platform 40. The load cells 76 communicate a signal to the processor 60 that is representative of the weight, i.e., mass of the object 42. The load cells 76 can be of any type such as are generally understood in the relevant art. Alternatively, the load cells 76 could be in the form of switches that are actuated when a predetermined non-nominal load is applied to the platform 40. In this regard, it is understood that the load cells 76 are not necessarily intended to measure at all times the weight of the object 42 for purposes of assessing the nature and quality of the activity of the fork lift 16. It can therefore be understood that a signal from a switch as the load cell 76, which would indicate that a load of some type is present on the platform 40, which would in turn indicate the existence of some type of object situated thereon, can be an appropriate signal to indicate that the platform 40 is in a laden condition rather than an unladen condition. As such, the load cells 76 potentially could be in the simple form of switches depending upon the desired complexity of the activity reporting system 4.

In this regard, it is understood that the activity reporting system 4 is intended to characterize the extent to which the fork truck 16 is “active” and the extent to which the fork truck 16 is “inactive” during a given period of time, with “active” and “inactive” typically being predefined by a user according to various criteria that may be of some importance to the user.

The fork truck 16 can be in any of a variety of situations at any given time. For instance, the fork truck 16 can be switched OFF. Alternatively, the fork truck 16 can be switched ON with its engine idling and with its platform 40 unladen. Alternatively, the fork truck 16 can be traveling, i.e., with its engine at a normal operating speed, with its platform 40 unladen. Such a situation would occur, for instance, once the fork truck 16 has unloaded the object 42 at the desired destination and the fork truck 16 is making a return trip to collect another object 42.

Still alternatively, the fork truck 16 can be operating with its engine at idle speed and with its platform 40 loaded. Such a situation may occur, for instance, while the fork truck 16 is at a standing stop while waiting in a line for some operation or during a measurement procedure on the object 42, by way of example. Still alternatively, the fork truck 16 may be traveling from one location to another with its platform 40 laden with the object 42 thereon.

The fork truck 16 in its OFF condition would probably be considered by anyone to be a period of inactivity. The fork truck 16 in a condition moving from one location to another, i.e., being in motion, with the object 42 situated on its platform 40 likewise would probably be considered by anyone to be a period of activity. However, the other situations in which the fork truck 16 may exist as set forth above potentially can be considered to be either periods of activity or periods of inactivity depending upon the needs of the user and depending upon the intended use of the resultant data. For example, one person might define a period during which the fork truck 16 is at an idle with its platform 40 loaded to be a period of inactivity because the person is trying to evaluate the effect of delay such as when the fork truck 16 is standing in line for some purpose. On the other hand, another person might define the same periods to be periods of activity since the platform 40 is carrying the object 42 and the person is trying to evaluate the extent to which the fork truck 16 is unladen.

The activity detection system 20 further comprises a transceiver 72 connected with the processor 60 and which is in wireless communication with the reporting device 8. The transceiver 72 in the exemplary embodiment includes both a transmitter and a receiver, although it is understood that in other embodiments the transceiver 72 may be merely in the form of a transmitter which transmits a signal that is received by the reporting device 8. The transceiver 72 may be configured to operate continuously or may provide burst data at various times. Still alternatively, the transceiver 72 may transmit to the reporting device 8 all of the data relevant to the fork truck 16 that has been collected during the period from when the time the fork truck 16 was switched to an ON condition until the time it is switched to an OFF condition.

In the exemplary embodiment depicted herein, the movement detector 56 comprises an accelerometer 80, a tachometer 84, and a speedometer 88. By way of example, the accelerometer 80 can detect acceleration and deceleration, and this data can be used with time data to derive a velocity of the fork truck 16. The tachometer 84 measures engine speed and can provide an indication of the velocity of the fork truck 16 if gearing ratios and the like are known. Likewise, the speedometer 88 directly measures velocity of the fork truck 16. It is understood that other embodiments of the movement detector 56 likely will include fewer than all of the accelerometer 80, tachometer 84, and speedometer 88 since the velocity of the fork truck 16 can be determined using any of these devices.

The load detector 52 provides input to the processor 60 that is indicative of loading on the platform 40, and the movement detector 56 provides to the processor 60 input that is indicative of movement of the fork truck 16. In this regard, it is understood that other embodiments of the activity detection system 20 may provide indications only of loading or only of movement, depending upon the needs of the application. For example, it is understood that many forklifts are already equipped with load cells that are intended to measure the weight of a parcel disposed thereon. By connecting a processor apparatus as described herein to the preexisting load cells, an activity detection system 20 as described herein can be formed. While such an activity detection system 20 may not include a movement detector 56, it is possible that the user may be content with defining periods of activity as being those where the forklift is loaded, and by defining periods of inactivity as being those where the forklift is unloaded. Such a scenario would be very cost effective due to the limited additional equipment that would need to be retrofitted to the forklift to form the resultant activity detection system 20. By the same token, such a limited system might further include a connection with the engine which would count the energizing operations of a spark plug over a period of time to gain an estimation of engine speed, which could give an indication of velocity of the forklift. This could be used as an additional or alternative criterion of activity. It thus is to be understood that various elements described herein can be employed or provided in any combination to provide indications of operations occurring on lift truck 16, and such indications can be used in various ways to determine data which is useful to a user.

Moreover, the various routines 68 that are executed on the processor 60 can perform various operations on signals generated by the load detector 52 and/or the movement detector 56, such as providing time stamps on data, compressing data, and filtering data using the filter routine 68 mentioned above. In this regard, it is understood that vibration on the fork truck 16 can result due to operation of its engine, which vibration typically is highly predictable based upon the dynamics of its engine and its operating speed. Other sources of vibration would include the treads on the wheels of the drive train 24 as the fork truck 16 is driven from one location to another, as well as vibrations from the floor itself due to uneven pavement, bumps and cracks in pavement, and the like. Since the object 42 itself has a certain mass, the signal from the load cells 76, by way of example, will indicate both the weight of the object 42 and will include some additional signal noise due to vibration of the object 42 on the platform 40. It is noted, however, that the load cells 76 can generate such a vibration signal even if the platform 40 is free of the object 42 because the platform 40 itself has mass, and it thus will vibrate and will cause a corresponding signal from the load cells 76 even when the fork truck 16 is unloaded.

As suggested, two highly predictable sources of vibration that are manifested in the signals generated by the load cells 76 are engine vibration and vibration in the drive train 24 due to movement of the fork truck 16. Some of the routines 68 that are executable on the processor 60 thus can determine that certain vibrations are the result of engine operation and can employ such vibrations to gauge engine speed, which can be used to derive a velocity of the fork truck 16. Similarly, vibrations that are detected as being due to driving of the fork truck 16 on a floor can likewise be used to derive a velocity of the fork truck 16. Such vibrations can also be manifested in the signals from the accelerometer 80 or in the signals generated by any other sensor of a similar nature that might be provided on the fork truck 16.

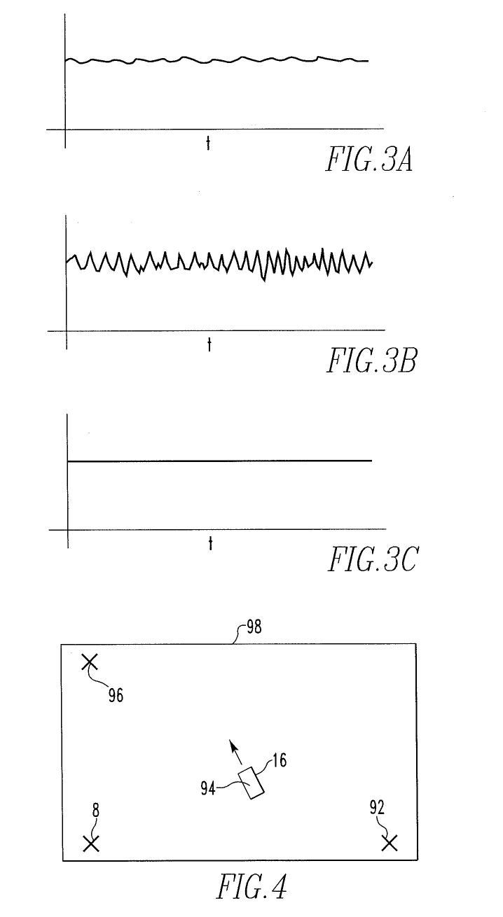

Not only can such vibrations be detected as having a particular origin, but the filter routine 68 can furthermore filter such vibrations from the signal from the load cells 76 in order to generate a “clean” signal that is free of vibration artifact. FIGS. 3A-3C, which are collectively referred to herein as FIG. 3, depict three exemplary signals that might be received from the load cells 76. FIG. 3A is indicative of a signal from the load detector 52 when the platform 40 has the object 42 situated thereon but also with the signal including an artifact of vibration resulting from operation of the engine, such as during idling of the engine. The FIG. 3B is similar to that of FIG. 3A, but the signal additionally includes vibration artifact that results from driving of the fork truck 16 along a floor. The filter routine 68 advantageously is configured to recognize such artifacts and to filter them from the signals received from the load cells 76 to result, by way of example, in the processed signal indicated generally in FIG. 3C, which is filtered and is largely free of the artifacts depicted in an exemplary fashion in the upper two signals. In this regard, it is understood that the various components of the movement detector 56 likewise may need filtration with the filter routine 68 or other appropriate routines as desired. Also, other types of noise may desirably be filtered from any of the signals depending upon the needs of the application.

As an alternative, the movement detector 56 might operate by detecting the position of the fork truck 16 at various locations about a facility 98, as is indicated generally in FIG. 4. The reporting device 8 will include its own transceiver, as mentioned above, and may be situated at a first location in the facility 98. The fork truck 16 would include a wireless transmitter 94 that wirelessly outputs electromagnetic energy that is detectable by the reporting device 8. The activity reporting system 4 may further include a second transceiver 92 and possibly a third transceiver 96 each disposed at other locations within the facility 98. The reporting device 8 may cooperate with the second and third transceivers 92 and 96 to employ triangulation or to detect Doppler shifting of the signal from the transceiver 72 on the fork truck 16, or they may otherwise employ signals received thereon or generated thereby to discern both the direction and velocity of the fork truck 16 during movement of the fork truck 16 about the facility 98. In this regard, two or more of the reporting device 8, the second transceiver 92, and the third transceiver 96 may be in wireless communication with one another, and/or at least one of the second and third transceivers 92 and 96 may be in wireless communication with the wireless transmitter 94. Alternatively, a position of the fork truck 16 may be determined by such system if the fork truck 16 is in a stationary condition. Such a system likely would not need to employ the filter routine 68.

It thus can be seen that the activity detection system 20 can detect the various operating parameters of the fork truck 16 at any given time, and such operating parameters can be employed by a user based upon pre-established criteria to allow the user to determine periods of activity and periods of inactivity of the fork truck 16. The activity detection system 20, when installed on the fork truck 16, becomes a component of the fork truck 16, and the two thus form the fork truck system 12 that can communicate with the reporting device 8. Any number of the fork truck systems 12 can be simultaneously operational within the facility 98. The various components of the activity detection system 20 may be situated within a common housing or may be distributed about the fork truck 16 without departing from the present concept. The activity reporting system 4 thus advantageously enables the user to gain a better understanding of the type of utilization of the fork truck 16, which improves efficiency.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An activity detection system for use on a lift truck and comprising:
a detection apparatus comprising at least one of a load detector and a movement detector; and
a processor apparatus comprising a storage for storing an output from the detection apparatus.

2. The activity detection system of claim 1 wherein the detection apparatus comprises as a load detector a load cell structured to generate a signal representative of a weight of an object situated on a platform of the lift truck.

3. The activity detection system of claim 2 wherein the processor apparatus further comprises a filter structured to operate on the signal from the load cell and to output a processed signal that is representative of the weight of the object and that has removed therefrom at least a portion of an artifact of at least one of vibration due to movement of the lift truck and vibration due to operation of an engine of the lift truck.

4. The activity detection system of claim 1 wherein the detection apparatus comprises as a movement detector at least one of an accelerometer that is structured to generate a signal representative of an acceleration of the lift truck and a tachometer that is structured to generate a signal representative of a velocity of the lift truck.

5. The activity detection system of claim 1 wherein the processor apparatus further comprises a communication apparatus structured to output an activity signal representative of at least a portion of the output of the detection apparatus.

6. The activity detection system of claim 5 wherein the communication apparatus comprises a wireless transmitter structured to wirelessly transmit the activity signal to a reporting device that is separate from the detection apparatus.

7. An activity reporting system comprising the activity detection system of claim 6, and further comprising a fork truck and a reporting device that is separate from the detection apparatus, the detection apparatus being installed on the fork truck, the wireless transmitter being in wireless communication with the reporting device.

8. A fork truck system comprising a fork truck and the activity detection system of claim 1 installed on the fork truck.
